(19) United States
(12) Patent Application Publication
(10) Pub. No.: US 2026/0120683 A1
(43) Pub. Date: Apr. 30, 2026

(54) METHOD FOR TRAINING AUDIO RECOGNITION MODEL, ELECTRONIC DEVICE, AND COMPUTER-READABLE STORAGE MEDIUM

(71) Applicant: MASHANG CONSUMER FINANCE CO., LTD., Chongqing (CN)

(72) Inventor: Qinglin MENG, Chongqing (CN)

(21) Appl. No.: 19/243,869

(22) Filed: Jun. 20, 2025

(30) Foreign Application Priority Data
Oct. 29, 2024 (CN) 202411523333.2

(51) Int. Cl. G10L 15/06; G06N 3/0455; G06N 3/09; G10L 15/16

(52) U.S. Cl. CPC G10L 15/063; G06N 3/0455; G06N 3/09; G10L 15/16

(57) ABSTRACT

A method for training an audio recognition model, an electronic device, and a computer-readable storage medium are provided The method includes: performing feature fusion on an audio feature and a related phrase feature, to obtain a first fused feature; performing phrase prediction based on the first fused feature and the audio feature, to obtain a first predicted phrase, and determining a first loss; performing text prediction based on the audio feature, the phrase feature and the first fused feature, to obtain a first predicted text, and determining a second loss; performing text prediction on an audio sample based on the audio feature and the first fused feature, to obtain a second predicted text, and determining a third loss based on the second predicted text and a text label; and training the audio recognition model based on the first loss, the second loss and the third loss.

### CROSS-REFERENCE TO RELATED APPLICATION

This application claims the benefit of priority of Chinese Patent Application No. 202411523333.2, filed on Oct. 29, 2024, the contents of which are incorporated herein by reference in its entirety for all purposes.

### BACKGROUND

With the development of technology, end-to-end audio recognition systems have made significant progress. In the related art, there are audio recognition models that incorporate an Attention Encoder-Decoder (AED) to realize audio recognition. However, when a training set lacks rare vocabulary, or vocabulary for a specific scenario, such as personal names or place names, a model in the related art often has poor recognition capability for these phrases that are not present in conventional training data.

### SUMMARY

Embodiments of the present disclosure provide a method for training an audio recognition model, an electronic device, and a computer-readable storage medium.

The technical solutions in the embodiments of the present disclosure are implemented as follows.

An embodiment of the present disclosure provides a method for training an audio recognition model, the method including: performing feature fusion on an audio feature of an audio sample and a phrase feature of the audio sample, to obtain a first fused feature; performing phrase prediction on the audio sample based on the first fused feature and the audio feature, to obtain a first predicted phrase, and determining a first loss, based on the first predicted phrase and a phrase label of the audio sample; performing text prediction on the audio sample based on the audio feature, the phrase feature and the first fused feature, to obtain a first predicted text, and determining a second loss based on the first predicted text and a text label of the audio sample; performing text prediction on the audio sample based on the audio feature and the first fused feature, to obtain a second predicted text, and determining a third loss based on the second predicted text and the text label; and training the audio recognition model based on the first loss, the second loss and the third loss.

An embodiment of the present disclosure provides an electronic device, including: a memory for storing computer-executable instructions or a computer program; and a processor, configured to execute the computer-executable instructions or the computer program stored in the memory to implement operations of: performing feature fusion on an audio feature of an audio sample and a phrase feature of the audio sample, to obtain a first fused feature; performing phrase prediction on the audio sample based on the first fused feature and the audio feature, to obtain a first predicted phrase, and determining a first loss, based on the first predicted phrase and a phrase label of the audio sample; performing text prediction on the audio sample based on the audio feature, the phrase feature and the first fused feature, to obtain a first predicted text, and determining a second loss based on the first predicted text and a text label of the audio sample; performing text prediction on the audio sample based on the audio feature and the first fused feature, to obtain a second predicted text, and determining a third loss based on the second predicted text and the text label; and training the audio recognition model based on the first loss, the second loss and the third loss.

An embodiment of the present disclosure provides a computer-readable storage medium having stored thereon a computer program or computer-executable instructions that when executed by a processor, implements or implement a method, the method including: performing feature fusion on an audio feature of an audio sample and a phrase feature of the audio sample, to obtain a first fused feature; performing phrase prediction on the audio sample based on the first fused feature and the audio feature, to obtain a first predicted phrase, and determining a first loss, based on the first predicted phrase and a phrase label of the audio sample; performing text prediction on the audio sample based on the audio feature, the phrase feature and the first fused feature, to obtain a first predicted text, and determining a second loss based on the first predicted text and a text label of the audio sample; performing text prediction on the audio sample based on the audio feature and the first fused feature, to obtain a second predicted text, and determining a third loss based on the second predicted text and the text label; and training the audio recognition model based on the first loss, the second loss and the third loss.

### BRIEF DESCRIPTION OF THE DRAWINGS

FIG. 1 is a schematic diagram of a structure of a training system architecture of an audio recognition model according to an embodiment of the present disclosure;

FIG. 2 is a schematic diagram of a structure of an electronic device according to an embodiment of the present disclosure;

FIG. 3A is a schematic flowchart of a method for training an audio recognition model according to an embodiment of the present disclosure;

FIG. 3B is a schematic flowchart of a phrase prediction method according to an embodiment of the present disclosure;

FIG. 3C is a first schematic flowchart of a text prediction method according to an embodiment of the present disclosure;

FIG. 3D is a second schematic flowchart of a text prediction method according to an embodiment of the present disclosure;

FIG. 3E is a schematic flowchart of a loss determination method according to an embodiment of the present disclosure;

FIG. 4 is a schematic diagram of a model structure of an audio recognition model according to an embodiment of the present disclosure.

FIG. 5 is a schematic diagram of a structure of a bias layer according to an embodiment of the present disclosure; and

FIG. 6 is a schematic diagram of a structure of a bias decoder according to an embodiment of the present disclosure.

It is to be noted that “first” and “second” above are only used to distinguish different solutions, and do not represent a degree of superiority or inferiority of the solutions, or a priority in the implementation procedure.

### DETAILED DESCRIPTION

To make the objectives, technical solutions, and advantages of the present disclosure clearer, the present disclosure will be described in further detail below with reference to the drawings. The described embodiments should not be regarded as limiting the present disclosure. All other embodiments that are obtained by those of ordinary skill in the art without involving inventive skill fall within the scope of protection of the present disclosure.

When the following description refers to “some embodiments”, the phrasing describes a subset of all possible embodiments, but it can be understood that “some embodiments” may be the same subset or different subsets of all possible embodiments, and may be combined with each other without conflict.

The term “first\second\third” as referred to in the following description is only to distinguish similar objects, and does not represent a specific ordering of objects. It can be understood that the specific order or sequential order of “first\second\third” may be interchanged if allowed, so that the embodiments of the present disclosure described herein can be implemented in an order other than those illustrated or described herein.

In the embodiments of the present disclosure, the term “module” or “unit” refers to a computer program or a part of a computer program that has a predetermined function, works together with other related parts to achieve a predetermined objective, and may be implemented in whole or in part by using software, hardware (such as a processing circuit or a memory), or a combination thereof. Similarly, one processor (or a plurality of processors or memories) may be used to implement one or more modules or units. Furthermore, each module or unit may be a part of an integral module or unit that includes the functionality of the module or unit.

Unless otherwise defined, all technical and scientific terms used in the embodiments of the present disclosure have the same meanings as commonly understood by a person of ordinary skill in the technical field to which the present disclosure belongs. The terms used in the embodiments of the present disclosure are only for the purpose of describing the embodiments of the present disclosure, and are not intended to limit the present disclosure.

In the embodiments of the present disclosure, the relevant data collection processing, when applied to examples, should strictly obtain informed consent or separate consent for the personal information subject according to the requirements of relevant laws and regulations, and carry out subsequent data use and processing within the scope of the laws and regulations and the authorization of the personal information subject.

Before the embodiments of the present disclosure are further described in detail, the nouns and terms referred to in the embodiments of the present disclosure are illustrated. The nouns and terms referred to in the embodiments of the present disclosure are applicable to the following explanations.
1) An Attention Encoder-Decoder (AED) is a technology widely applied in the field of deep learning, and allows the model to selectively focus on important parts and ignore unimportant information when processing information. The AED mimics the behavior of human attention concentration; that is, when processing a task, people typically focus on the most critical information, and ignore other interfering information. In deep neural networks, the AED is typically used in sequence-to-sequence (seq2seq) models, particularly in fields such as machine translation, speech recognition and natural language processing. A basic principle of the AED is to determine which parts are important by means of calculating the correlation between a query, a key, and a value.
2) A deep bias method means that, in a training procedure of a deep learning model, a specific bias term or bias mechanism is introduced to affect weight updating and a learning procedure of the model, thereby improving performance of the model in a specific task. In machine learning and deep learning, the deep bias method refers to a technology for improving model performance by introducing a specific bias. These biases may be explicit or implicit, and are intended to guide the model to more effectively capture specific features or patterns of data in a learning procedure.
3) Explicit decoding refers to a procedure of directly converting encoded data into original data by means of a predefined rule and algorithm. This type of decoding means typically has well-defined steps and predictable behavior, such as predictability: the decoding procedure and behavior are predefined, and the result is easy to predict; transparency: the decoding procedure is transparent and easy to understand and debug; and efficiency: for simple or structured data, explicit decoding is typically more efficient.
4) Implicit decoding refers to a process of learning an implicit relationship between an input and an output by means of a neural network or another complex model, to implement data decoding. This type of decoding manner does not depend on a well-defined decoding step, and has: flexibility: an ability to handle complex and unstructured data; adaptivity: models may adapt to different data distributions by means of training; black-box nature: the decoding procedure is opaque and difficult to interpret.

With the development of technology, end-to-end audio recognition systems have made significant progress. In the related art, there are audio recognition models that incorporate an AED to realize audio recognition. However, when a training set lacks rare vocabulary or vocabulary for a specific scenario, such as personal names, place names and the like, models in the related art often have poor recognition capability for these phrases that are not in conventional training data.

In this regard, in related research, a simple language model cascade fusion is selected to correct deviation of phrase recognition, which can improve recognition accuracy of some specific phrases to some extent, but has a limited effect on an entire phrase list. Although embedding of a language model enhances context output, overall performance of the model is not significantly improved, especially when phrases outside the training set are processed. In order to solve this problem, a deep bias method based on a neural network is also introduced in the related art. In comparison, the deep bias method can be better integrated seamlessly with a network of an audio recognition model, and can learn a capability to recognize a specific phrase by capturing a phrase pattern in training data.

However, in an existing audio recognition model combined with the deep bias method, there is no method combining explicit decoding and implicit decoding strategies, and deeper phrase information is not fully utilized to strengthen information fusion between a network of an audio recognition model and a deep bias network.

Embodiments of the present disclosure provide a method and apparatus for training an audio recognition model, an electronic device, a computer-readable storage medium, and a computer program product, which can fully fuse phrase information to train a model, thereby improving audio recognition accuracy.

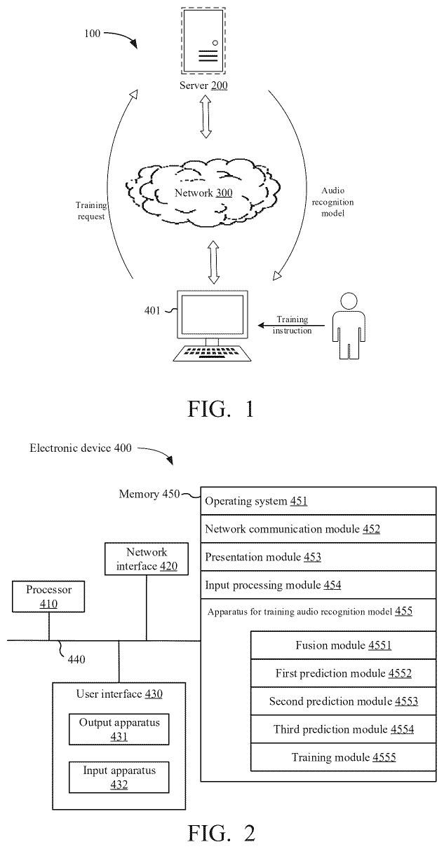

Referring to FIG. 1, FIG. 1 is a schematic diagram of an architecture of a training system 100 for an audio recognition model according to an embodiment of the present disclosure. In order to support a training application of an audio recognition model, a terminal 401 is connected to a server 200 by means of a network 300. The network 300 may be a wide area network or a local area network, or a combination of a wide area network and a local area network.

The terminal 401 is used to send a training request to the server 200 in response to a training instruction for an audio recognition model. The server 200 is used to: acquire an audio sample from the terminal 401 in response to the training request, and perform feature fusion on an audio feature of the audio sample and a phrase feature related to the audio sample, to obtain a first fused feature; perform phrase prediction on the audio sample based on the first fused feature and the audio feature, to obtain a first predicted phrase, and determine a first loss based on the first predicted phrase and a phrase label of the audio sample; based on the audio feature, the phrase feature and the first fused feature, perform text prediction on the audio sample, to obtain a first predicted text, and determine a second loss based on the first predicted text and a text label of the audio sample; perform text prediction on the audio sample based on the audio feature and the first fused feature, to obtain a second predicted text, and determine a third loss based on the second predicted text and the text label; and train the audio recognition model based on the first loss, the second loss and the third loss.

In some embodiments, the server 200 may directly send an audio recognition model trained in response to the training request to the terminal 401. The terminal 401 may also actively acquire a trained audio recognition model from the server 200.

In some embodiments, the terminal 401 may be implemented as various types of terminal, such as a notebook computer, a tablet computer, a desktop computer, a set-top box, a smart phone, a smart speaker, a smart watch, a smart television, or an in-vehicle terminal, or may be implemented as a server.

In some embodiments, the server 200 may be an independent physical server, or may be a server cluster or a distributed system composed of a plurality of physical servers, or may be a cloud server that provides basic cloud computing services such as cloud services, cloud databases, cloud computing, cloud functions, cloud storage, network services, cloud communication, middleware services, domain name services, security services, content delivery networks (CDN) and big data and artificial intelligence platforms. The terminal and the server may be directly or indirectly connected by wired or wireless communication means, which is not limited in the embodiments of the present disclosure.

Referring to FIG. 2, FIG. 2 is a schematic diagram of a structure of an electronic device 400 according to an embodiment of the present disclosure. The electronic device 400 shown in FIG. 2 includes: at least one processor 410, a memory 450, at least one network interface 420, and a user interface 430. Various components in the electronic device 400 are coupled together by means of a bus system 440. It may be understood that the bus system 440 is used to implement connection and communication between these components. The bus system 440, in addition to a data bus, includes a power supply bus, a control bus, and a status signal bus. However, for the sake of clear illustration, the various buses are all designated as the bus system 440 in FIG. 2.

The processor 410 may be an integrated circuit chip having signal processing capabilities, such as a general-purpose processor, a digital signal processor (DSP), or another programmable logic device, a discrete gate or transistor logic device, a discrete hardware component, or the like. The general-purpose processor may be a microprocessor, any conventional processor, or the like.

The user interface 430 includes one or more output apparatuses 431 that enable presentation of media content, including one or more speakers and/or one or more visual display screens. The user interface 430 further includes one or more input apparatuses 432, including user interface components that facilitate user input, such as a keyboard, a mouse, a microphone, a touchscreen display screen, a camera, or another input button and control.

The memory 450 may be removable, non-removable, or a combination thereof. An exemplary hardware device includes a solid-state memory, a hard disk drive, an optical-disc drive, or the like. The memory 450 optionally includes one or more memory devices physically located remote from the processor 410.

The memory 450 includes a volatile memory or a nonvolatile memory, or may include both a volatile memory and a nonvolatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 can store data to support various operations. Examples of the data include programs, modules and data structures, or a subset or superset thereof, as exemplarily described below.

An operating system 451 includes a system program used to process various basic system services and execute hardware-related tasks, such as a framework layer, a core library layer, and a driver layer, and used to implement various basic services and process hardware-based tasks.

A network communication module 452 is used to access another electronic device via one or more (wired or wireless) network interfaces 420. An exemplary network interface 420 includes: Bluetooth, wireless compatibility authentication (Wi-Fi), a universal serial bus (USB), and the like.

A presentation module 453 is used to present information via one or more output apparatuses 431 (for example, a display screen, a speaker, or the like) associated with a user interface 430 (for example, a user interface for operating a peripheral device and display content and information).

An input processing module 454 is used to detect one or more user inputs or interactions from one of the one or more input apparatuses 432, and translate the detected inputs or interactions.

In some embodiments, an apparatus for training an audio recognition model according to an embodiment of the present disclosure may be implemented using software means, and FIG. 2 shows an apparatus 455 for training an audio recognition model stored in a memory 450, which may be software in a form of a process, a plug-in and the like, including the following software modules: a fusion module 4551, a first prediction module 4552, a second prediction module 4553, a third prediction module 4554 and a training module 4555, these modules being logical modules, and thus capable of being arbitrarily combined or further split according to the functions implemented. Functions of the modules are described hereinafter.

In some other embodiments, the apparatus for training an audio recognition model according to an embodiment of the present disclosure may be implemented using hardware means. As an example, the apparatus for training an audio recognition model according to an embodiment of the present disclosure may be a processor in the form of a hardware decoding processor which is programmed to perform the method for training an audio recognition model according to an embodiment of the present disclosure. For example, the processor in the form of a hardware decoding processor may use one or more application specific integrated circuits (ASIC), digital signal processors (DSP), programmable logic devices (PLD), complex programmable logic devices (CPLD), field-programmable gate arrays (FPGA) or other electronic elements.

Hereinafter, a method for training an audio recognition model according to an embodiment of the present disclosure is described in combination with the accompanying drawings. As described above, the electronic device 400 for implementing the method for training an audio recognition model in the embodiment of the present disclosure may be a terminal 401, a server 200, or a combination of a terminal 401 and a server 200. Therefore, an execution subject of each step will not be described repeatedly below.

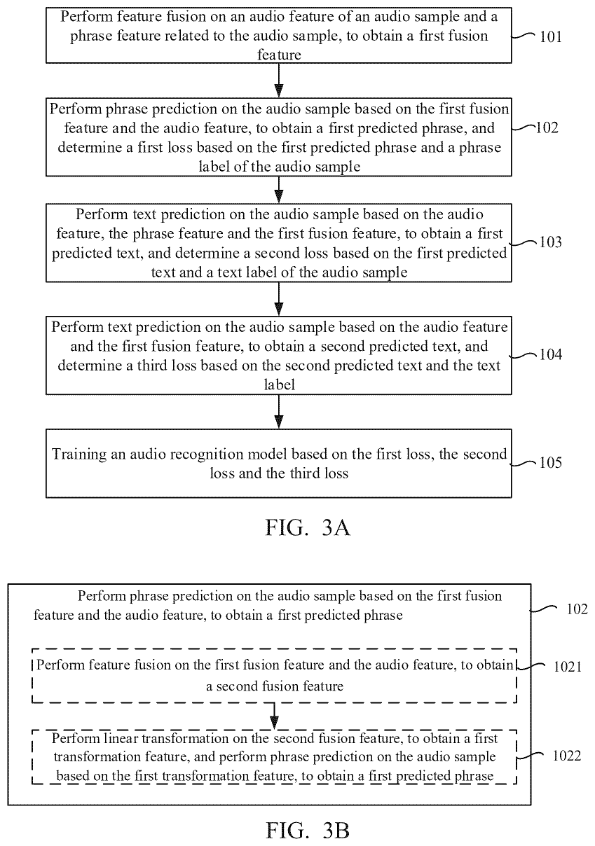

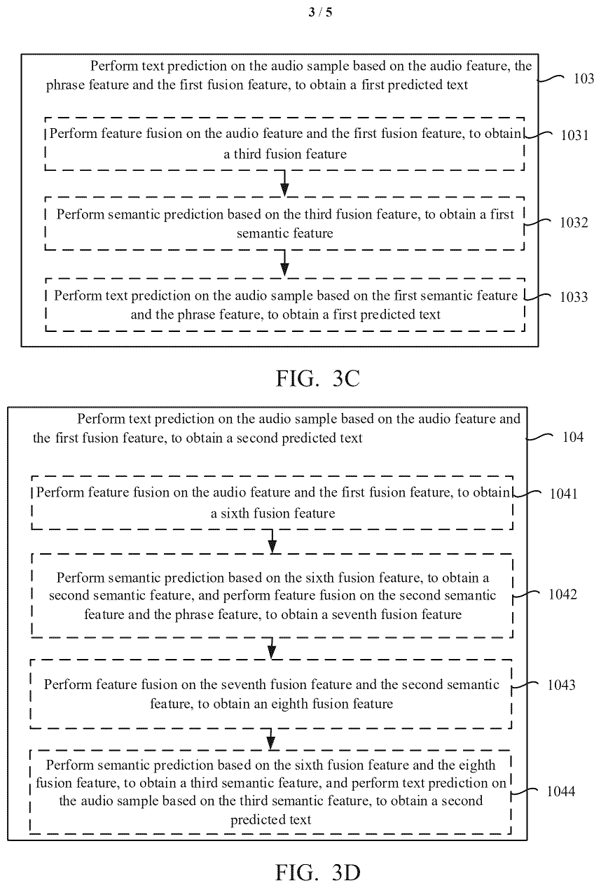

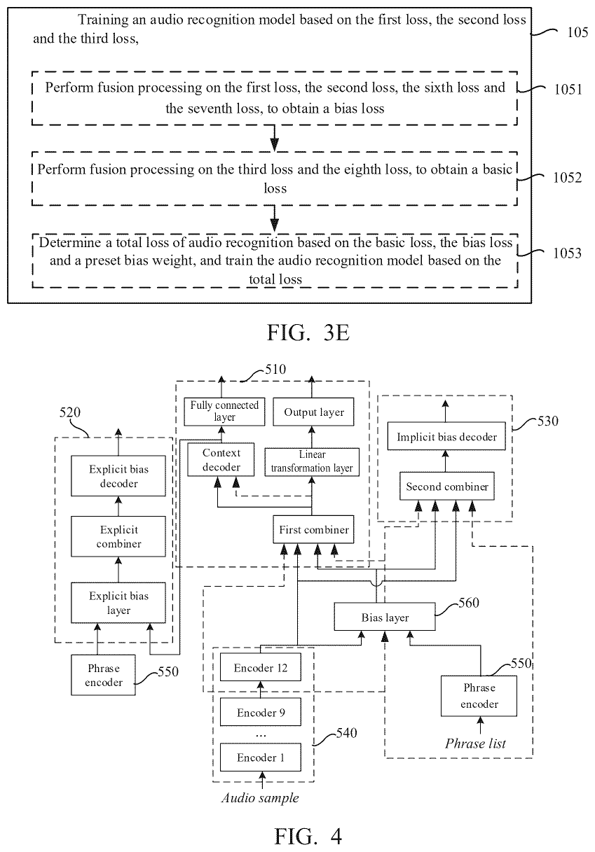

The method for training an audio recognition model in the embodiments of the present disclosure is described using an example in which the execution subject is the server 200. Referring to FIG. 3A, FIG. 3A is a schematic flowchart of a method for training an audio recognition model according to an embodiment of the present disclosure, and the method is described with reference to the steps shown in FIG. 3A.

Step 101: feature fusion is performed on an audio feature of an audio sample and a phrase feature related to the audio sample, to obtain a first fused feature.

In the embodiments of the present disclosure, an audio sample refers to fragmentary audio data used for audio processing, analysis, and recognition, and is used to train an audio recognition model to recognize different audio features. During training, an audio sample set may include a plurality of audiobook audios in different languages.

An audio sample includes a phrase audio clip corresponding to a specific phrase. Here, the specific phrase may be an obscure vocabulary item, like a personal name or a place name, technical vocabulary in some technical field (for example, financial technical vocabulary in the financial field), or a popular vocabulary item frequently used within a specific period (for example, metaverse or digital economy).

During actual training, a phrase list for specific phrases may be constructed according to an actual task requirement. In one possible implementation, a specified quantity of specific phrases within a specified word length range may be randomly extracted from a text transcription of each audio sample in the audio sample set, and the extracted specific phrases added to the phrase list as a training positive sample. Then, a specific phrase of the same type that has not appeared in the audio sample is selected and added to the phrase list as a training negative sample, to simulate the introduction of an interference term in reality. In addition, phrase lists having different list lengths may also be constructed to perform training according to actual training requirements.

FIG. 4 is a schematic diagram of a model structure of an audio recognition model according to an embodiment of the present disclosure. Hereinafter, the model structure of the audio recognition model in the present disclosure is described with reference to FIG. 4. Referring to FIG. 4, the audio recognition model includes a basic model 510, an explicit network branch 520 and an implicit network branch 530. The basic model 510 is used to perform text recognition on an audio sample and predict complete text information corresponding to the audio sample; the explicit network branch 520 predicts complete text information corresponding to the audio sample based on an explicit decoding means; and the implicit network branch 530 predicts phrase information for specific phrases included in the audio sample based on an implicit decoding means.

The audio recognition model further includes an audio encoder 540 for performing feature extraction on the audio sample, the audio encoder including 12 layers of encoders. After the audio sample is input to the audio encoder 540, acoustic feature extraction may be performed on the audio sample by means of the 12 layers of encoders, to obtain an audio feature corresponding to the audio sample (denoted as

$${h}_{t}^{E} ) .$$

The audio recognition model further includes a phrase encoder 550 for performing feature extraction on the phrase list, and a bias layer 560 for performing feature fusion on the audio feature and the phrase feature.

In actual implementation, because the phrase list includes a phrase that is not involved in the audio sample (i.e., an interference item), a phrase feature related to the audio sample may be first selected before the bias layer 560 performs feature fusion to obtain the first fused feature, so as to focus attention on the related phrase feature, thereby improving phrase recognition accuracy. Here, the phrase feature related to the audio sample is a phrase feature corresponding to a phrase related to the audio sample, and the phrase related to the audio sample may be a phrase involved in the audio sample or a phrase having a high similarity with the phrase involved in the audio sample in terms of semantics, pronunciation or the like, e.g., a phrase having a similarity higher than a preset similarity.

As an example, the audio sample is a Chinese spoken voice corresponding to the text “an end-to-end deep learning model, for example, a speech recognition system, may effectively capture long-distance acoustic dependence and sequence context information by means of a self-AED and position encoding”, phrases involved in the audio sample including “end-to-end”, “self-attention”, and “acoustic dependence”; the preset phrase list includes several technical vocabulary items related to speech recognition, and the phrase list at least includes the phrases in the audio sample “end-to-end”, “self-attention”, and “acoustic dependence”. In this way, based on the AED, phrases related to the audio sample may be selected from the phrase list by using a degree of attention that the audio feature of the audio sample pays to a phrase feature of each phrase in the phrase list. That is, the phrase feature related to the audio sample is obtained. Here, the phrases related to the audio sample that are selected may include the three phrases “end-to-end”, “self-attention” and “acoustic dependence”, and other phrases in the phrase list that have a high similarity to these three phrases in terms of semantics, pronunciation, or the like. In some embodiments, before step 101 is performed, the phrase feature related to the audio sample may be determined by the following means: performing feature extraction on a plurality of phrases in a phrase list, to obtain a phrase feature sequence including a plurality of phrase features; using the audio feature as a query feature vector in the AED, and using the phrase feature sequence as a key feature vector in the AED; determining a feature similarity between the audio feature and each phrase feature in the phrase feature sequence according to a dot product operation between the query feature vector and the key feature vector; and determining a phrase feature related to the audio feature in the phrase feature sequence based on the feature similarity.

In actual implementation, feature extraction may be first performed on a plurality of phrases in the phrase list by means of the phrase encoder 550, to obtain a phrase feature sequence including a plurality of phrase features. A network structure of the phrase encoder 550 may include a tokenizer, a bidirectional long short-term memory network, and a linear layer. When feature extraction is performed on the phrase list, each phrase in the phrase list may be first segmented based on the tokenizer, to obtain a sequence of text units. Here, a text unit may be a word, a character, a subword, or any other defined fragment; word segmentation is a procedure of segmenting the phrases in the phrase list into text units, and a standard of word segmentation may be set according to an actual requirement, and is not limited herein. Then, the sequence of text units obtained by the tokenizer is sent to the bidirectional long short-term memory network for context feature mapping, and an output of the bidirectional long short-term memory network is linearly transformed by means of the linear layer, to obtain context word embedding vectors (i.e., phrase features, which may be recorded as

$${h}_{i}^{C E} )$$

corresponding to a plurality of phrases in the phrase list, respectively, a plurality of phrase features constituting a phrase feature sequence.

It is to be noted that the phrase list may further include a context phrase composed of one blank text unit, to help the audio recognition model predict a text of the audio sample. If a sentence does not contain a phrase in the phrase list, but a corresponding vector still needs to be output, an empty vector of the blank text unit is used as a placeholder, so that the audio recognition model knows that the sentence does not include a phrase, so as to perform proper prediction.

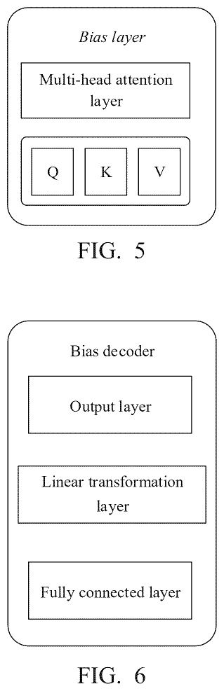

In actual implementation, referring to FIG. 5, the bias layer 560 may adopt a multi-head attention layer, use an AED, and add a screening algorithm to implement screening and feature fusion of phrase features, so as to help the audio recognition model learn a relationship between an audio sample and a phrase related to the audio sample. The audio feature

$${h}_{t}^{E}$$

of the audio sample may be used as a query feature vector in the AED, and the phrase feature sequence may be used as a key feature vector and a value feature vector in the AED. In the AED, the query feature vector (i.e., the Query feature) is a feature vector used to retrieve or search for related information, and represents the content that currently needs to be focused on or queried. The key feature vector (i.e., the Key feature) is a feature vector used for comparison with the query feature vector; the vector represents key information of each part in the input data, and is used to determine which parts are most related to the query feature vector. The value feature vector (i.e., the Value feature) is a feature vector used to generate a final output; the vector represents the detailed content of each part in the input data, and once it is determined which parts are related to the query feature vector, the value feature vector is weighted and summed to generate the final output.

In actual implementation, a dot product operation between the query feature vector (i.e., the audio feature) and the key feature vector (i.e., the phrase feature sequence) may be performed by using the following formula:

$${α}_{t} = Softmax ( ( {W}_{q} {h}_{t}^{E} ) {( {W}_{k} {h}_{i}^{C E} )}^{T} / sqr t ( d ) )$$

W_{q} represents a weight that is set for the query feature vector; Wₖ represents a weight that is set for the key feature vector; sqrt(d) represents a scaling factor, used to maintain numerical stability; T represents a duration of the audio sample, duration here being represented by a quantity of frames of the audio sample;

$${h}_{t}^{E}$$

represents the audio feature, i.e., the query feature vector;

$${h}_{i}^{C E}$$

represents the phrase feature in the phrase feature sequence, i.e., the key feature vector; Softmax (is an activation function which is used for probability prediction, and a role thereof is to map one vector into another vector, so that a range of each element is between (0,1), and the sum of all elements is 1, thereby forming a probability distribution; and at represents a feature similarity vector between the query feature vector (i.e., the audio feature) and the key feature vector (i.e., the phrase feature sequence), the probability distribution here representing feature similarity, which can reflect a degree of attention of the audio feature to each phrase feature, i.e., a degree of focus.

A result obtained by performing the dot product operation on the audio feature and the phrase feature sequence is converted into a visual attention map. The attention map can reflect a degree of focus of the query feature vector on each part of the key feature vector, that is, the attention map can reflect a degree of focus of each frame of audio of the audio sample on each phrase in the phrase list. The higher the feature similarity is, the higher the degree of focus is.

As an example, a phrase with a feature similarity higher than a preset similarity may be directly used as a phrase related to the audio sample.

As an example, phrases related to the audio sample may also be determined by means of performing screening on phrases based on a preset screening algorithm and an attention map: for each frame of audio of the audio sample, a number n of phrases (assuming n=2) having the highest degree of focus (feature similarity) of each frame of audio are determined in the attention map, then statistical calculation is performed on all the determined phrases, and if there is a phrase that is repeatedly present more than a number m of times (assuming m=5), the phrase is considered as a key phrase, i.e., a phrase related to the audio sample, and a phrase feature corresponding to the phrase is a phrase feature related to the audio feature. Here, n and m may be set according to actual conditions, or set in combination with historical experience; this is not limited herein.

After determining a phrase feature related to the audio feature, feature fusion of the audio feature and the related phrase feature may be implemented by using the following formula:

$${C}_{t}^{E} = {\sum }_{i = 0}^{K} {a}_{i t} {W}_{v} {h}_{i}^{C E}$$

K represents a quantity of phrases in the phrase list; Wᵥ represents a weight that is set for the value feature vector;

$${h}_{i}^{C E}$$

represents the phrase feature in the phrase feature sequence, i.e., the key feature vector; aᵢₜ represents a feature similarity corresponding to an i-th phrase; and

$${C}_{t}^{E}$$

represents the first fused feature.

It may be understood that, in the calculation of an AED, the obtained representation feature (i.e., the first fused feature) is actually a fusion of the audio feature and the related phrase feature, but is more inclined towards an audio-type feature. This is because, in the multi-head AED, the query feature vector dominates the allocation of attention weights, and since the audio feature is used as the query feature vector, the audio recognition model mainly focuses on how to select and weight the phrase features according to the audio feature. Although the final output is based on weighted summation of the phrase features (the value feature vectors), these weights are determined based on a query result of the audio feature. Therefore, the output representation feature (i.e., the first fused feature) more reflects information about the audio feature, and merely performs enhancement and refinement on phrase information by means of the phrase feature. This fusion means helps the audio recognition model to better understand and represent the relationship between the audio sample and the phrases, but the dominant feature is still the audio feature.

In the foregoing manner, when the phrase list is a long phrase list (i.e., when the phrase list includes a large quantity of interference items), some phrases related to the audio sample can be quickly selected by means of screening by the screening algorithm (for example, the phrase list includes 2000 phrases, and 100 related phrases may be determined after screening); then, subsequent model inference is performed based on related phrase features, so that the model can concentrate attention on the related phrases, thereby improving recognition accuracy of the phrases included in the audio sample.

With continued reference to FIG. 3A, the description continues with step 101.

Step 102: phrase prediction is performed on the audio sample based on the first fused feature and the audio feature, to obtain a first predicted phrase, and determine a first loss based on the first predicted phrase and a phrase label of the audio sample.

In actual implementation, referring to FIG. 4, after the bias layer performs feature fusion to obtain the first fused feature, the first fused feature may be given to the implicit network branch, so that the implicit network branch learns phrase information involved in the audio feature based on the first fused feature and the audio feature, thereby performing phrase prediction and loss calculation on the audio sample.

In some embodiments, referring to FIG. 3B, “performing phrase prediction on the audio sample based on the first fused feature and the audio feature, to obtain a first predicted phrase” in step 102 may be implemented by means of step 1021 and step 1022.

Step 1021: feature fusion is performed on the first fused feature and the audio feature, to obtain a second fused feature.

Referring to FIG. 4, the implicit network branch includes a second combiner and an implicit bias decoder. The second combiner is used to perform feature fusion on the first fused feature and the audio feature, to obtain the second fused feature. Here, when performing feature fusion, the second combiner may adopt any one of the following fusion means: feature splicing, i.e., directly splicing the first fused feature and the audio feature into a longer feature vector; feature weighted summation, i.e., performing weighted summation on an element at a vector position corresponding to the first fused feature and an element at a vector position corresponding to the audio feature; feature averaging, i.e., computing the average of an element at a vector position corresponding to the first fused feature and an element at a vector position corresponding to the audio feature; feature multiplication, i.e., multiplying an element at a vector position corresponding to the first fused feature and an element at a vector position corresponding to the audio feature; and feature interaction, i.e., generating new features, which are a combination of the first fused feature and the audio feature, such as an element-level product and a polynomial combination.

With continued reference to FIG. 3B, the description continues with step 1021.

Step 1022: linear transformation is performed on the second fused feature, to obtain a first transformed feature, and perform phrase prediction on the audio sample based on the first transformed feature, to obtain a first predicted phrase.

In actual implementation, referring to FIG. 6, FIG. 6 is a schematic diagram of a structure of a bias decoder according to an embodiment of the present disclosure. The audio recognition model shown in FIG. 4 includes two bias decoders, one being an implicit bias decoder in the implicit network branch, and the other being an explicit bias decoder in the explicit network branch. The network layer structures used by the two bias decoders are the same, but parameters of the two bias decoders are not shared, due to different decoding means and different learning objectives.

In actual implementation, after the second combiner performs feature fusion on the first fused feature and the audio feature, the implicit bias decoder performs linear transformation on the second fused feature based on a fully connected layer and a linear transformation layer, and performs phrase prediction on the audio sample by using the first transformed feature that is obtained by an output layer based on the linear transformation, to obtain a predicted phrase feature corresponding to the first predicted phrase (denoted as

$${C}_{t}^{E\_res} ) .$$

The fully connected layer is used to perform linear transformation on the second fused feature by means of a weight matrix and a bias vector, to generate a new feature combination. The linear transformation layer is used to perform pure linear transformation, and is typically used for data preprocessing or preliminary feature conversion.

Specifically, the predicted phrase feature corresponding to the first predicted phrase

$${C}_{t}^{E\_res}$$

may be calculated by using the following formula:

$${C}_{t}^{E\_res} = linear ( concat [ {C}_{t}^{E} , {h}_{t}^{E} ] )$$

represents the first fused feature;

$${h}_{t}^{E}$$

represents the audio feature;

$${C}_{t}^{E\_res}$$

represents the predicted phrase feature of the first predicted phrase;

$$concat [ {C}_{t}^{E} , {h}_{t}^{E} ]$$

represents that feature fusion processing is performed on the first fused feature and the audio feature; and the function linear ( ) represents linear transformation processing.

In actual implementation, when feature fusion and phrase prediction are performed, the concept of a residual may be used for reference, so that acoustic information in the audio feature can be more effectively transmitted to the implicit bias decoder, to assist the implicit bias decoder in participating in phrase prediction, and loss calculation can be performed based on a phrase prediction result. The first loss may be specifically calculated by using the following formula:

$${ℒ}_{b i a {s}_{-} i m p} = C T C ( {C}_{t}^{{E}_{res}} , {Y}_{b i a s}^{l a b e l} )$$

[symbol] _{bias_imp} represents the first loss, which may also be represented as an implicit bias loss of the implicit network branch;

$${C}_{t}^{{E}_{res}}$$

represents the predicted phrase feature of the first predicted phrase;

$${Y}_{bias}^{label}$$

represents a labeled phrase label for a phrase involved in the audio sample; and the function CTC( ) represents calculation of a connectionist temporal classification (CTC) bias loss based on the first predicted phrase and the phrase label.

It is to be noted that the CTC bias loss allows the model to directly output sequence labels without the need to align an input sequence. That is, a core concept of the CTC bias loss is to map the input sequence (for example, the predicted phrase feature) to one sequence of labels (for example, characters or phonemes), and to allow some parts of the input sequence to not correspond to any label (i.e., a blank label). CTC deals with the problem of misalignment between an input sequence and a sequence of phrase labels by introducing an additional blank label (typically denoted as “-”). The CTC bias loss is an improvement on a standard CTC loss, and is intended to solve some specific problems, such as the bias problem of phrase labels of the audio sample in the embodiments of the present disclosure. Specifically, the CTC bias loss introduces a phrase bias term to a calculation procedure to adjust weights of different labels.

In the described manner, the implicit network branch does not depend on a predefined decoding rule, so that a complex mapping relationship between an audio sample and phrases involved may be learned, thereby enhancing the capability of the audio recognition model to learn phrases.

With continued reference to FIG. 3A, the description continues with step 102.

Step 103: text prediction is performed on the audio sample based on the audio feature, the phrase feature and the first fused feature, to obtain a first predicted text, and determine a second loss based on the first predicted text and a text label of the audio sample.

In actual implementation, referring to FIG. 4, the explicit network branch may use the phrase feature sequence output by the phrase encoder 550 and the first semantic feature obtained after the first fused feature and the audio feature are processed by the basic model as input, and perform explicit decoding based on the first semantic feature and the phrase feature sequence, so as to perform text prediction and loss calculation on the audio sample based on fusion phrase information, thereby improving accuracy of prediction of phrases involved when the audio recognition model predicts a complete text.

In some embodiments, referring to FIG. 3C, “performing text prediction on the audio sample based on the audio feature, the phrase feature and the first fused feature, to obtain a first predicted text” in step 103 may be implemented by means of step 1031 to step 1033.

Step 1031: feature fusion is performed on the audio feature and the first fused feature, to obtain a third fused feature.

In actual implementation, referring to FIG. 4, the first fused feature output by the bias layer 560 may be used as input for the first combiner, the input for the first combiner further including the audio feature output by the audio encoder 540, and the first combiner may perform feature fusion on the first fused feature and the audio feature to obtain a third fused feature (denoted as

$${h}_{t}^{C A} ) .$$

Here, the first combiner and the second combiner may adopt the same feature fusion means, or may adopt different feature fusion means according to actual conditions, e.g., any one of the following fusion means: feature splicing, feature weighted summation, feature averaging, feature multiplication, and feature interaction. Feature fusion may also be performed on the first fused feature

$${C}_{t}^{E}$$

and the audio feature

$${h}_{t}^{E}$$

by using the following formula to obtain a third fused feature with phrase perception

$${h}_{t}^{CA} : {h}_{t}^{CA} = FeedForward ( {W}_{bias \_ score} Linear ( {C}_{t}^{E} ) + {h}_{t}^{E} )$$

$${C}_{t}^{E}$$

represents the first fused feature;

$${h}_{t}^{E}$$

represents the audio feature;

$${h}_{t}^{CA}$$

represents the third fused feature; and W_{bias_score} represents a constant, used to represent a degree of focus on a phrase-biased latent vector in the first fused feature. The function Linear( ) represents that linear transformation is performed on the first fused feature, typically represented as matrix multiplication and addition of bias terms; and FeedForward ( ) is an encapsulation of one feedforward neural network layer, and represents that a calculation procedure in parentheses is treated as a whole feedforward layer.

Step 1032: semantic prediction is performed based on the third fused feature, to obtain a first semantic feature.

In actual implementation, a context decoder in the basic model 510 typically refers to a decoding strategy that can improve accuracy of semantic recognition by using context information; context information here may include time sequence information in audio information, context information in a language model, and context information in an acoustic model. By using the context decoder, semantic prediction may be performed on the third fused feature that fuses the audio information and the phrase information, and semantic learning is performed based on the audio information and the phrase information, to obtain the first semantic feature (denoted as

$${h}_{m}^{D} ) .$$

Step 1033: text prediction is performed on the audio sample based on the first semantic feature and the phrase feature, to obtain a first predicted text.

In some embodiments, step 1033 may be implemented by the following means: perform feature fusion on the first semantic feature and the phrase feature, to obtain a fourth fused feature; perform feature fusion on the fourth fused feature and the first semantic feature, to obtain a fifth fused feature; perform linear transformation on the fifth fused feature, to obtain a second transformed feature, and perform text prediction on the audio sample based on the second transformed feature, to obtain a first predicted text.

In actual implementation, referring to FIG. 4, the explicit network branch 520 includes an explicit bias layer, an explicit combiner, and an explicit bias decoder. The explicit bias layer, like the bias layer 560, adopts a multi-head attention layer, and uses the Attention Encoder-Decoder in combination with the screening algorithm to implement screening of the phrase feature sequence and feature fusion of the phrase feature and the first semantic feature, to obtain the fourth fused feature (denoted as

$${C}_{m}^{D} ) ,$$

where m represents a quantity of predicted text units.

Then, the explicit combiner may perform feature fusion on the fourth fused feature output by the explicit bias layer and the first semantic feature, to obtain a fifth fused feature (denoted as

$${h}_{m}^{CA} ) .$$

Here, because the phrase feature is fused in the fourth fused feature and the first semantic feature also has phrase perception, the fifth fused feature

$${h}_{m}^{CA}$$

also has phrase perception information. The explicit combiner may perform feature fusion on the first semantic feature and the fourth fused feature by the same fusion means (for example, feature weighted summation) as the second combiner and the first combiner. It is to be noted that the explicit combiner, the first combiner and the second combiner may adopt the same network structure, but because features to be fused are different and fusion focuses are also different, parameters of the three combiners are not shared, and the parameters are adjusted independently in a model training procedure.

Referring to FIG. 6, the explicit bias decoder in the explicit network branch also includes a fully connected layer, a linear transformation layer and an output layer. After receiving the fifth fused feature, the explicit bias decoder may perform linear transformation on the fifth fused feature by means the fully connected layer and the linear transformation layer, and perform text prediction based on the second transformed feature obtained through the linear transformation through the output layer, to obtain a first predicted text feature corresponding to the first predicted text (denoted as

$${C}_{m}^{D \_ res} ) .$$

Specifically, the first predicted text feature corresponding to the first predicted text may be calculated by means of the following formula

$${C}_{m}^{D \_ res} : {C}_{m}^{D \_ res} = linear ( concat [ {C}_{m}^{D} , {h}_{m}^{D} ] )$$

$${C}_{m}^{D}$$

represents the fourth fused feature;

$${h}_{m}^{D}$$

represents the first semantic feature;

$${C}_{m}^{D \_ res}$$

represents the first predicted text feature corresponding to the first predicted text;

$$concat [ {C}_{m}^{D} , {h}_{m}^{D} ]$$

represents that feature fusion processing is performed on the fourth fused feature and the first semantic feature; and the function linear ( ) represents linear transformation processing.

In actual implementation, when feature fusion and text prediction are performed, the concept of a residual may also be used for reference, so that acoustic information in the first semantic feature can be more effectively transmitted to the explicit bias decoder, so as to assist the explicit bias decoder in performing text prediction, loss calculation may be performed based on a first text prediction result, and the second loss may be specifically calculated by using the following formula:

$${ℒ}_{bias \_ exp} = Label\_smooth \_CE ( {C}_{m}^{{D}_{res}} , {Y}_{text}^{label} )$$

$${C}_{m}^{{D}_{res}}$$

represents the first predicted text feature corresponding to the first predicted text;

$${Y}_{text}^{label}$$

represents a labeled text label for the audio sample, and the text label represents accurate text information of the audio sample; [symbol] _{bias_exp} represents the second loss, and may also be represented as an explicit bias loss of the explicit network branch; and

$$Label\_smooth \_CE ( {C}_{m}^{{D}_{res}} , {Y}_{text}^{label} )$$

represents that a cross-entropy loss is calculated based on the first predicted text and the text label.

In the foregoing manner, the second loss may enable phrase enhancement information to be reflected in text semantics learning, so that a predicted text can pay more attention to phrase bias; and an objective of learning based on the loss is to make phrases in a predicted text result more accurate by means of adding the phrase bias.

In some embodiments, the fourth fused feature may be obtained by the following means: use the first semantic feature as a query feature vector in an AED, and use the phrase feature as a key feature vector and a value feature vector in the AED; determine an attention weight based on a degree of attention of the query feature vector to the key feature vector; and perform a dot product operation on the attention weight and the value feature vector, to obtain a fourth fused feature.

In actual implementation, refer to the processing procedure and related formulas when the bias layer performs feature fusion on the audio feature and the phrase feature to obtain the first fused feature in the above embodiment. Here, the first semantic feature may be used as the query feature vector in the AED, the phrase feature may be used as the key feature vector and the value feature vector in the AED, and a degree of focus (i.e., the degree of attention) of the query feature vector on the key feature vector may be determined by means of the dot product operation, thereby obtaining the attention weight. It may be understood that the attention weight here is equivalent to the feature similarity in the above embodiment of the bias layer. Then, a fourth fused feature with phrase perception and semantic enhancement is obtained based on a dot product operation of the attention weight and the phrase feature.

With continued reference to FIG. 3A, the description continues with step 103.

Step 104: text prediction is performed on the audio sample based on the audio feature and the first fused feature, to obtain a second predicted text, and determine a third loss based on the second predicted text and the text label.

In some embodiments, referring to FIG. 4, the basic model may perform text prediction based on the audio feature and the first fused feature independently.

In actual implementation, feature fusion is performed on the audio feature and the first fused feature by using a first combiner, to obtain a third fused feature; semantic prediction is performed on the third fused feature based on the context decoder, to obtain a first semantic feature; and linear transformation is performed on the first semantic feature based on the fully connected layer and the linear transformation layer in the basic model, and text prediction is performed on the audio sample based on the first semantic feature after the linear transformation by using the output layer, to obtain a second predicted text. In addition, the third loss is determined based on the second predicted text and the text label carried in the audio sample.

In this manner, when performing text prediction, the basic model adopts the first fused feature fusing the phrase feature, which can enhance a learning capability of phrases through fused phrase information, and improve prediction accuracy of phrases included in the second predicted text.

In some embodiments, referring to FIG. 3D, “performing text prediction on the audio sample based on the audio feature and the first fused feature, to obtain a second predicted text” in step 104 may be implemented by means of step 1041 to step 1044.

Step 1041: feature fusion is performed on the audio feature and the first fused feature, to obtain a sixth fused feature.

In actual implementation, step 1041 is also performed by the first combiner, and is the same as a procedure of the first combiner performing feature fusion on the audio feature and the first fused feature in the described embodiment. The sixth fused feature is also the same as the third fused feature. For a specific feature fusion procedure, reference may be made to the above related embodiments of the first combiner, and details will not be described again here.

Step 1042: semantic prediction is performed based on the sixth fused feature, to obtain a second semantic feature, and perform feature fusion on the second semantic feature and the phrase feature, to obtain a seventh fused feature.

In actual implementation, “performing semantic prediction based on the sixth fused feature, to obtain a second semantic feature” in Step 1042 is also performed by the context decoder, which is the same as a procedure of the context decoder performing semantic prediction based on the third fused feature, to obtain the first semantic feature, in the above embodiment. For a specific procedure, reference may be made to the above related embodiments, and details will not be described again here.

“Performing feature fusion on the second semantic feature and the phrase feature, to obtain a seventh fused feature” in Step 1042 is performed by the explicit bias layer, and is the same as a procedure of the explicit bias layer performing feature fusion on the first semantic feature and the phrase feature, to obtain the fourth fused feature, in the above embodiment. For a specific fusion procedure, reference may be made to the above related embodiments, and details will not be described again here.

Here, the second semantic feature is the same as the first semantic feature, and the seventh fused feature is the same as the fourth fused feature.

Step 1043: feature fusion is performed on the seventh fused feature and the second semantic feature, to obtain an eighth fused feature.

In actual implementation, step 1043 is performed by the explicit combiner, which is the same as a procedure of the explicit combiner performing feature fusion on the fourth fused feature and the first semantic feature, to obtain the fifth fused feature, in the above embodiment. For a specific fusion procedure, reference may be made to the above related embodiments, and details will not be described again here.

Here, the eighth fused feature is the same as the fifth fused feature.

Step 1044: semantic prediction is performed based on the sixth fused feature and the eighth fused feature, to obtain a third semantic feature, and perform text prediction on the audio sample based on the third semantic feature, to obtain a second predicted text.

In actual implementation, after outputting the eighth fused feature, the explicit combiner may use the eighth fused feature in reverse as input of the context decoder, so that the context decoder can perform semantic prediction in combination with the eighth fused feature and the sixth fused feature; then, the fully connected layer and the linear transformation layer perform linear transformation on the third semantic feature obtained from semantic prediction; and finally, text prediction is performed based on the third semantic feature after linear transformation by means of the output layer, to obtain the second predicted text predicted by the basic model.

In actual implementation, alternatively, when performing text prediction, the explicit network branch directly outputs the fifth fused feature output by the explicit combiner in reverse to the context decoder in the basic model; then, the context decoder in the basic model performs semantic prediction based on the fifth fused feature and the third fused feature, and the fully connected layer and the linear transformation layer perform linear transformation on the third semantic feature obtained from semantic prediction; and finally, text prediction is performed based on the third semantic feature after linear transformation through the output layer, to obtain the second predicted text predicted by the basic model. In this way, there is no need to repeatedly perform step 1041 to step 1043.

In the foregoing manner, the basic model is made to perform text prediction in combination with the fifth fused feature in the explicit network branch, so that the basic model can further enhance phrase perception capability, and make full use of feature information with a deeper level to strengthen information fusion between the basic model and a deep bias network (the explicit network branch), thereby improving accuracy of text prediction of the basic model, and making predicted phrases included in the second predicted text more accurate.

In some embodiments, “determining a third loss based on the second predicted text and the text label” in step 104 may be implemented by the following means: determine a fourth loss and a fifth loss based on the second predicted text and the text label, the fourth loss being used to represent a degree of sequence alignment between the second predicted text and the text label, and the fifth loss being used to represent a degree of label difference between the second predicted text and the text label; and determine the third loss based on the fourth loss and the fifth loss.

In actual implementation, when performing loss calculation, the basic model calculates two types of losses. One is the fourth loss (denoted as [symbol] _{CTC}), used to represent a degree of sequence alignment between the second predicted text and the text label; the fourth loss may also be referred to as a sequence alignment loss; a calculation method of the fourth loss is the same as the calculation method of the first loss in the above embodiment, and the CTC ( ) Function may be adopted to perform calculation of the connectionist temporal classification (CTC) bias loss based on the second predicted text and the text label. The other is the fifth loss (denoted as [symbol] ₐₜₜ), used to represent a degree of label difference between the second predicted text and the text label; the fifth loss may also be referred to as a label difference loss. The second loss may be calculated by adopting the described calculation means for calculating the second loss, and the function Label_smooth_CE( ) is used to calculate a label smoothing cross-entropy loss. Here, it is to be noted that the fifth loss may be obtained by calculating a label smoothing cross-entropy loss between the third semantic feature and the text label. Specifically, a formula of the fifth loss may be:

$${ℒ}_{a t t} = Label\_smooth \_CE ( {C}_{m}^{CA} , {Y}_{text}^{label} )$$

$${C}_{m}^{CA}$$

represents the third semantic feature; and

$${Y}_{text}^{label}$$

represents the text label.

In actual implementation, after the fourth loss [symbol] _{CTC} and the fifth loss [symbol] ₐₜₜ are calculated, a sum value of the fourth loss and the fifth loss may be used as the third loss, or the third loss may be obtained by performing a weighted summation of the fourth loss and the fifth loss.

With continued reference to FIG. 3A, the description continues with step 104.

Step 105: the audio recognition model is trained based on the first loss, the second loss and the third loss.

In actual implementation, after the basic model, the explicit network branch and the implicit network branch obtain respective loss values, related parameters of each network layer in the audio recognition model may be reverse adjusted based on the three losses, so as to improve recognition capability of the audio recognition model.

In some embodiments, when training is performed on the audio recognition model, the training may also be performed in combination with an intermediate-layer audio feature of the audio sample: extract an intermediate-layer audio feature from the audio sample; perform feature fusion based on the intermediate-layer audio feature and the phrase feature related to the audio sample, to obtain a ninth fused feature; perform phrase prediction on the audio sample based on the ninth fused feature and the intermediate-layer audio feature, to obtain a second predicted phrase, and determine a sixth loss based on the second predicted phrase and the phrase label; perform text prediction on the audio sample based on the ninth fused feature, the intermediate-layer audio feature and the phrase feature, to obtain a third predicted text, and determine a seventh loss based on the third predicted text and the text label; and perform fourth text prediction on the audio sample based on the ninth fused feature and the intermediate-layer audio feature, to obtain a fourth predicted text, and determine an eighth loss based on the fourth predicted text and the text label.

In actual implementation, because the audio encoder 540 has a plurality of layers of encoders, output of an encoder at a specific intermediate layer may be used to obtain the intermediate-layer audio feature of the audio sample. For example, for 12 layers of encoders of the audio encoder, output of an encoder at a ninth layer may be used to obtain the intermediate-layer audio feature.

Then, on the basis of the bias layer 560 performing feature fusion on the intermediate-layer audio feature and the phrase feature related to the audio sample, the ninth fused feature is obtained. Here, the feature fusion procedure of the bias layer 560 is the same as the procedure of performing feature fusion on the audio feature and the related phrase feature, to obtain the first fused feature, in the above embodiment, except that the audio feature is adjusted to be the intermediate-layer audio feature. Next, on the basis of the implicit network branch performing phrase prediction by using the intermediate-layer audio feature and the ninth fused feature, a predicted phrase feature of the second predicted phrase (denoted as

$${C}_{t}^{{E}_{res \_ mid}} )$$

is obtained. Here, the processing procedure of the implicit network branch is the same as the above procedure of processing the first fused feature and the audio feature, except that the audio feature is adjusted to be the intermediate-layer audio feature. The implicit network branch may calculate the sixth loss by means of the following formula:

$${ℒ}_{bias \_ imp \_ mid} = CTC ( {C}_{t}^{{E}_{res \_ mid}} , {Y}_{bias}^{label} )$$

[symbol] _{bias_imp_mid} represents the sixth loss, and may also be represented as an intermediate-layer implicit bias loss of the implicit network branch;

$${C}_{t}^{{E}_{res \_ mid}}$$

represents the predicted phrase feature of the second predicted phrase;

$${Y}_{bias}^{label}$$

represents a labeled phrase label for a phrase involved in the audio sample; and the function CTC( ) represents calculation of a connectionist temporal classification (CTC) bias loss based on the second predicted phrase and the phrase label.

Synchronously, the explicit network branch may perform text prediction on the audio sample based on the ninth fused feature, the intermediate-layer audio feature and the phrase feature, to obtain a third predicted text feature of the third predicted text (denoted as

$${C}_{m}^{{D}_{res \_} mid} ) ,$$

and determine the seventh loss based on the third predicted text and the text label. Here, for a procedure of the explicit network branch performing text prediction, reference may be made to the procedure of the explicit network branch performing text prediction on the audio sample based on the first fused feature, the audio feature, and the phrase feature in the above embodiment, and details will not be described again here. The explicit network branch may specifically calculate the seventh loss by using the following formula:

$${ℒ}_{bias \_ exp \_ mid} = Label\_smooth \_CE ( {C}_{m}^{{D}_{res \_} mid} , {Y}_{text}^{label} )$$

$${C}_{m}^{{D}_{res \_} mid}$$

represents the third predicted text feature corresponding to the third predicted text;

$${Y}_{text}^{label}$$

represents a labeled text label for the audio sample, and the text label represents accurate text information of the audio sample; [symbol] _{bias_exp_mid} represents the seventh loss, and may also be represented as an intermediate-layer explicit bias loss of the explicit network branch; and

$$Label\_smooth \_CE ( {C}_{m}^{{D}_{res \_} mid} , {Y}_{text}^{label} )$$

represents that a cross-entropy loss is calculated based on the third predicted text and the text label.

Synchronously, the basic model may perform fourth text prediction on the audio sample based on the ninth fused feature and the intermediate-layer audio feature, to obtain a fourth predicted text, and determine an eighth loss (denoted as [symbol] _{att_mid}) based on the fourth predicted text and the text label, which may also be referred to as an intermediate-layer sequence alignment loss. Here, reference may be made to the procedure of the basic model performing text prediction on the audio sample based on the first fused feature and the audio feature in the above embodiment, and details will not be described again here. The basic model may determine the eighth loss [symbol] _{att_mid} by the calculation means [symbol] ₐₜₜ, and details will not be described again here.

In actual implementation, transmission of the intermediate-layer audio feature may be implemented by means of introducing a shared decoder, and a reason why the shared decoder can play a role is that the shared decoder can play a role similar to a residual network for information transmission of an encoder (for example, a context encoder or a phrase encoder), and information of an intermediate layer of the audio encoder may be conveniently transmitted to the encoder (for example, the context encoder or the phrase encoder) through a shared decoder branch, and during training, the information is fed back to the intermediate layer of the audio decoder, which simplifies information gradient transmission. Therefore, a bias-based shared decoder is added to the audio recognition model, which can help to increase information transfer flow of phrase bias information, and increase information acquisition capability of the audio recognition model for phrase bias information.

In the described means, during model training, the intermediate-layer audio feature is extracted from the audio encoder, and the audio recognition model is preferentially made to learn based on the intermediate-layer audio feature, which enables a low-level network layer of an encoder (for example, a context encoder or a phrase encoder) to receive glyph information earlier, thereby achieving a better audio recognition effect.

In some embodiments, referring to FIG. 3E, step 105 may be implemented by means of step 1051 to step 1053.

Step 1051: fusion processing is performed on the first loss, the second loss, the sixth loss and the seventh loss, to obtain a bias loss.

In actual implementation, fusion processing may be performed on the first loss, the second loss, the third loss, the sixth loss and the seventh loss in a weighted summation manner, to obtain the bias loss. It may be understood that the bias loss is used to represent a total loss of the implicit network branch and the explicit network branch.

Specifically, the bias loss may be calculated by using the following formula:

$${ℒ}_{bias} = {λ}_{1} {ℒ}_{bias \_ imp} + ( 1 - {λ}_{1} ) {ℒ}_{bias \_ imp \_ mid} + {ℒ}_{bias \_ exp} + ( 1 - {λ}_{1} ) {ℒ}_{bias \_ exp \_ mid}$$

Here, [symbol] _{bias} represents the bias loss; [symbol] _{bias_imp} represents the first loss; [symbol] _{bias_exp} represents the second loss; [symbol] _{bias_exp_mid} represents the seventh loss; [symbol] _{bias_imp_mid} represents the eighth loss; and λ₁ and (1−λ₁) represent weights.

Here, the weights of the first loss and the second loss are the same, the weights of the seventh loss and the eighth loss are the same, and the sum of the weights of the two is a preset value (for example, 1).

Step 1052: fusion processing is performed on the third loss and the eighth loss, to obtain a basic loss.

In actual implementation, the third loss includes the fourth loss and the fifth loss, the fusion processing means may also be weighted summation, and the basic loss may also be understood as an automatic speech recognition (ASR) loss, which is referred to as an ASR loss for short.

Specifically, the basic loss may be calculated by using the following formula:

$${ℒ}_{asr} = ( 1 - {λ}_{1} ) {ℒ}_{CTC} + {λ}_{1} ( ( 1 - {λ}_{1} ) {ℒ}_{att} + {λ}_{1} {ℒ}_{att \_ mid} )$$

[symbol] ₐₛᵣ represents the basic loss; [symbol] _{CTC} represents the fourth loss; [symbol] ₐₜₜ represents the fifth loss; [symbol] _{att_mid} represents the eighth loss; and λ₁, (1−λ₁), and λ₁((1−λ₁) represent weights.

Step 1053: a total loss of audio recognition is determined based on the basic loss, the bias loss, and a preset bias weight, and train the audio recognition model based on the total loss.

In actual implementation, weighted summation may be performed on the basic loss and the bias loss, to determine the total loss of the audio recognition.

Specifically, the total loss of audio recognition may be calculated by using the following formula:

$${ℒ}_{total} = {ℒ}_{asr} + {λ}_{2} {ℒ}_{bias}$$

[symbol] ₜₒₜₐₗ represents the total loss, [symbol] ₐₛᵣ represents the basic loss, [symbol] _{bias} represents the bias loss, and λ₂ represents a weight.

In actual implementation, the related parameters of the audio recognition model may be adjusted in reverse by means of the calculated total loss of audio recognition, so as to perform iterative training on the audio recognition model. When an iterative training end condition is met, a trained audio recognition model is obtained, and the iterative training end condition may be: A quantity of times of iterative training reaches a preset quantity of times, and the total loss reaches a preset loss.

In the foregoing means, during model training, the basic loss is combined with the bias loss to adjust in reverse the parameters of the audio recognition model, which may realize combination of explicit and implicit decoding, thereby strengthening information fusion between the basic model and the deep bias network by using deep phrase bias information, improving audio recognition capability of the audio recognition model, and making predicted phrases in the text information more accurate.

In the foregoing means, when model training is performed on the audio recognition model, feature fusion may be performed on the audio feature of the audio sample and the phrase feature related to the audio sample, then phrase prediction may be performed by using the first fused feature obtained through feature fusion and the audio feature, text prediction may be performed by using the audio feature, the phrase feature and the first fused feature, and text prediction may be performed by using the first fused feature and the audio feature, thereby training the audio recognition model in reverse by combining loss values of the three types of prediction manners. In this way, the phrase feature can be better fused into model training, and the audio recognition model can learn deeper phrase information, thereby accurately recognizing specific phrases involved in an audio, and improving accuracy of audio recognition.

In some embodiments, because the implicit network branch is intended to predict phrases involved in an audio, when a trained audio recognition model is applied to perform audio recognition, the implicit network branch does not work, and only the basic model and the explicit network branch are used to predict text corresponding to the audio. This is because, in the training procedure, parameters of the entire model have been adjusted in reverse in combination with prediction of the implicit network branch for phrases, so a text prediction result of the audio by the basic model is more accurate. In this way, during use, because parameters of the explicit network branch and the basic model are adjusted based on impact of the implicit network branch on phrase prediction, phrases in text obtained directly through prediction of the explicit network branch and the basic model are more accurate.

As an example, when the audio recognition model is applied to perform audio recognition, an audio to be recognized is a Chinese voiced speech corresponding to the text “an end-to-end deep learning model, for example, a speech recognition system, may effectively capture long-distance acoustic dependence and sequence context information by means of a self-AED and position encoding”, and a preset phrase list includes several technical words related to speech recognition, the phrase list including at least the phrases “end-to-end”, “self-attention”, and “acoustic dependence” in the above text. Then, the audio to be recognized and the phrase list may be input into the trained audio recognition model, and in combination with the prediction of the basic model and the explicit network branch, the text “an end-to-end deep learning model, for example, a speech recognition system, may effectively capture long-distance acoustic dependence and sequence context information by means of a self-AED and position encoding” predicted for the audio to be recognized may be obtained. In addition, the phrases “end-to-end”, “self-attention”, and “acoustic dependence” included in the predicted text are accurate and free of typos.

In a specific embodiment, when the audio recognition model is trained, an English speech recognition data set may be selected as training data, and the corpus includes 960 hours of English audiobook speech (i.e., an audio sample set). After performing training based on all 960 hours of training data, speech data subsets in the training data separately representing different recording conditions, such as a dev-clean subset and a dev-other subset, may be used for verification, whereas a test-clean subset and a test-other subset are used to perform final evaluation of model training.

In a training procedure, three phrases having lengths of 1 to 3 words may be randomly extracted from transcribed text of each speech in the training data, and added to the batch of phrase lists as positive samples. Then 57 phrases not present in the batch of transcriptions may be selected from all transcriptions as negative samples, to simulate interference items when the phrase list is introduced in reality.

In the test phase, the phrase lists provided above are also used, with list lengths of 100, 500, 1000 and 2000, respectively. For the evaluation index, a word error rate (WER), a biased word error rate (B-WER), and an unbiased word error rate (U-WER) may be used. The biased word error rate is calculated for phrases present in the phrase list, whereas the unbiased word error rate is calculated for words not present in the phrase list.

In order to apply the proposed processing procedure of the intermediate-layer audio feature, the basic model of the model structure shown in FIG. 4 may be used to train a basic model combined with a shared decoder, the training performed iteratively for 120 times, a learning rate set to 0.01, and 10 audio recognition models in training with the lowest average verification set loss finally selected for model averaging; this model is used as the basic model in FIG. 4. In addition, in the above formula for calculating the loss, λ₁ may be set to 0.3, and λ₂ may be set to 0.03. During decoding, W_{bias_score} is set to 1.2.

Compared with a baseline model, under the same model calculation amount, when the length of the phrase list is 100, the word error rate and the biased word error rate in the training method of the embodiment of the present disclosure are improved by 29.53% and 52.34%, respectively. Compared with the audio recognition model in the related art, the word error rate and the biased word error rate are improved by 32.64% and 41.35%, respectively. It may be seen that the method for training an audio recognition model according to an embodiment of the present disclosure can effectively improve recognition accuracy of the audio recognition model.

Description of an exemplary structure of the apparatus 455 for training an audio recognition model according to an embodiment of the present disclosure implemented as software modules continues below. In some embodiments, as shown in FIG. 2, the software modules stored in the apparatus 455 for training an audio recognition model of the memory 450 may include a fusion module 4551, a first prediction module 4552, a second prediction module 4553, a third prediction module 4554 and a training module 4555.

The fusion module 4551 is configured to perform feature fusion on an audio feature of an audio sample and a phrase feature related to the audio sample, to obtain a first fused feature;

The first prediction module 4552 is configured to perform phrase prediction on the audio sample based on the first fused feature and the audio feature, to obtain a first predicted phrase, and determine a first loss based on the first predicted phrase and a phrase label of the audio sample;

The second prediction module 4553 is configured to perform text prediction on the audio sample based on the audio feature, the phrase feature and the first fused feature, to obtain a first predicted text, and determine a second loss based on the first predicted text and a text label of the audio sample;

The third prediction module 4554 is configured to perform text prediction on the audio sample based on the audio feature and the first fused feature, to obtain a second predicted text, and determine a third loss based on the second predicted text and the text label; and

The training module 4555 is configured to train the audio recognition model based on the first loss, the second loss and the third loss.

In some embodiments, the apparatus 455 for training an audio recognition model further includes a screening module configured to: perform feature extraction on a plurality of phrases in the phrase list, to obtain a phrase feature sequence including a plurality of phrase features; use the audio feature as a query feature vector in an AED, and use the phrase feature sequence as a key feature vector in the AED; determine a feature similarity between the audio feature and each phrase feature in the phrase feature sequence according to a dot product operation between the query feature vector and the key feature vector; and determine a phrase feature related to the audio feature in the phrase feature sequence based on the feature similarity.

In some embodiments, the first prediction module 4552 is further configured to: perform feature fusion on the first fused feature and the audio feature, to obtain a second fused feature; and perform linear transformation on the second fused feature, to obtain a first transformed feature, and perform phrase prediction on the audio sample based on the first transformed feature, to obtain a first predicted phrase.

In some embodiments, the second prediction module 4553 is further configured to: perform feature fusion on the audio feature and the first fused feature, to obtain a third fused feature; perform semantic prediction based on the third fused feature, to obtain a first semantic feature; and perform text prediction on the audio sample based on the first semantic feature and the phrase feature, to obtain a first predicted text.

In some embodiments, the second prediction module 4553 is further configured to: perform feature fusion on the first semantic feature and the phrase feature, to obtain a fourth fused feature; perform feature fusion on the fourth fused feature and the first semantic feature, to obtain a fifth fused feature; and perform linear transformation on the fifth fused feature, to obtain a second transformed feature, and perform text prediction on the audio sample based on the second transformed feature, to obtain a first predicted text.

In some embodiments, the second prediction module 4553 is further configured to: use the first semantic feature as a query feature vector in the AED, and use the phrase feature as a key feature vector and a value feature vector in the AED; determine an attention weight based on a degree of attention of the query feature vector to the key feature vector; and perform a dot product operation on the attention weight and the value feature vector, to obtain a fourth fused feature.

In some embodiments, the third prediction module 4554 is further configured to: perform feature fusion on the audio feature and the first fused feature, to obtain a sixth fused feature; perform semantic prediction based on the sixth fused feature, to obtain a second semantic feature, and perform feature fusion on the second semantic feature and the phrase feature, to obtain a seventh fused feature; perform feature fusion on the seventh fused feature and the second semantic feature, to obtain an eighth fused feature; and perform semantic prediction based on the sixth fused feature and the eighth fused feature, to obtain a third semantic feature, and perform text prediction on the audio sample based on the third semantic feature, to obtain a second predicted text.

In some embodiments, the third prediction module 4554 is further configured to: determine a fourth loss and a fifth loss based on the second predicted text and the text label; the fourth loss being used to represent a degree of sequence alignment between the second predicted text and the text label, and the fifth loss being used to represent a degree of label difference between the second predicted text and the text label; and determine the third loss based on the fourth loss and the fifth loss.

In some embodiments, the apparatus 455 for training an audio recognition model further includes an intermediate-layer feature training module configured to: extract an intermediate-layer audio feature from the audio sample; perform feature fusion based on the intermediate-layer audio feature and the phrase feature related to the audio sample, to obtain a ninth fused feature; perform phrase prediction on the audio sample based on the ninth fused feature and the intermediate-layer audio feature, to obtain a second predicted phrase, and determine a sixth loss based on the second predicted phrase and the phrase label; perform text prediction on the audio sample based on the ninth fused feature, the intermediate-layer audio feature and the phrase feature, to obtain a third predicted text, and determine a seventh loss based on the third predicted text and the text label; and perform fourth text prediction on the audio sample based on the ninth fused feature and the intermediate-layer audio feature, to obtain a fourth predicted text, and determine an eighth loss based on the fourth predicted text and the text label.

In some embodiments, the training module 4555 is further configured to: perform fusion processing on the first loss, the second loss, the sixth loss and the seventh loss, to obtain a bias loss; perform fusion processing on the third loss and the eighth loss, to obtain a basic loss; and determine a total loss of audio recognition based on the basic loss, the bias loss and a preset bias weight, and train the audio recognition model based on the total loss.

The embodiments of the present disclosure have the following beneficial effects: in the foregoing manner, when training an audio recognition model, feature fusion may be performed on an audio feature of an audio sample and a phrase feature related to the audio sample, then phrase prediction may be performed by using a first fused feature obtained through feature fusion and the audio feature, text prediction may be performed by using the audio feature, the phrase feature and the first fused feature, and text prediction may be performed by using the first fused feature and the audio feature, so as to train the audio recognition model in reverse by combining loss values of the three prediction manners. In this way, the phrase feature can be better fused into model training, and the audio recognition model can learn deeper phrase information, thereby accurately recognizing phrases involved in audio, and improving audio recognition accuracy.

An embodiment of the present disclosure provides a computer program product, the computer program product including a computer program or a computer-executable instruction, and the computer program or the computer-executable instruction being stored in a computer-readable storage medium. A processor of an electronic device 400 reads the computer-executable instruction from the computer-readable storage medium, and the processor executes the computer-executable instruction to cause the electronic device 400 to execute a method for training an audio recognition model described above in the embodiments of the present disclosure.

An embodiment of the present disclosure provides a computer-readable storage medium, storing a computer-executable instruction or a computer program therein. When the computer-executable instruction or the computer program is executed by a processor, the processor is caused to perform the method for training an audio recognition model according to the embodiment of the present disclosure, for example, the method for training an audio recognition model shown in FIG. 3A.

In some embodiments, the computer-readable storage medium may be a memory such as a RAM, a ROM, a flash memory, a magnetic surface memory, an optical disc, or a CD-ROM, or may be various devices including one or any combination of the above memories.

In some embodiments, the computer-executable instruction may be in the form of a program, software, software module, script or code, and written in any form of programming language (including a compiled or interpreted language, or a declarative or procedural language), and may be deployed in any form, including as a stand-alone program or as a module, component, subroutine, or another unit suitable for use in a computing environment.

As an example, the computer-executable instruction may, but does not necessarily, correspond to a file in a file system, and may be stored in a part of a file storing other programs or data, for example, in one or more scripts in a hyper text markup language (HTML) document, in a single file dedicated to the program in question, or in a plurality of coordinated files (for example, files storing one or more modules, sub-programs, or code portions).

As an example, the computer-executable instruction may be deployed to be executed on one electronic device, or on a plurality of electronic devices located at one site, or on a plurality of electronic devices distributed at a plurality of sites and interconnected by a communication network.

In summary, in the foregoing means, when model training is performed on the audio recognition model, feature fusion may be performed on the audio feature of the audio sample and the phrase feature related to the audio sample, then phrase prediction maybe performed by using the first fused feature obtained through feature fusion and the audio feature, text prediction may be performed by using the audio feature, the phrase feature and the first fused feature, and text prediction may be performed by using the first fused feature and the audio feature, thereby training the audio recognition model in reverse by means of combining loss values of the three types of prediction means. In this way, the phrase feature can be better fused into model training, and the audio recognition model can learn deeper phrase information, thereby accurately recognizing specific phrases involved in an audio, and improving accuracy of audio recognition.

The foregoing contents are merely embodiments of the present disclosure, and are not intended to limit the scope of protection of the present disclosure. Any modifications, equivalent substitutions, improvements, etc. made within the spirit and scope of the present disclosure are encompassed within the scope of protection of the present disclosure.

1. A method for training an audio recognition model, comprising:
performing feature fusion on an audio feature of an audio sample and a phrase feature related to the audio sample, to obtain a first fused feature;
performing phrase prediction on the audio sample based on the first fused feature and the audio feature, to obtain a first predicted phrase, and determining a first loss based on the first predicted phrase and a phrase label of the audio sample;
performing text prediction on the audio sample based on the audio feature, the phrase feature and the first fused feature, to obtain a first predicted text, and determining a second loss based on the first predicted text and a text label of the audio sample;
performing text prediction on the audio sample based on the audio feature and the first fused feature, to obtain a second predicted text, and determining a third loss based on the second predicted text and the text label; and
training the audio recognition model based on the first loss, the second loss and the third loss.

2. The method according to claim 1, wherein before the performing feature fusion on an audio feature of an audio sample and a phrase feature related to the audio sample, the method further comprises:
performing feature extraction on a plurality of phrases in a phrase list, to obtain a phrase feature sequence comprising a plurality of phrase features;
using the audio feature as a query feature vector in an Attention Encoder-Decoder (AED), and using the phrase feature sequence as a key feature vector in the AED;
determining a feature similarity between the audio feature and each phrase feature in the phrase feature sequence, according to a dot product operation between the query feature vector and the key feature vector; and
determining a phrase feature related to the audio feature from the phrase feature sequence based on the feature similarity.

3. The method according to claim 1, wherein performing phrase prediction on the audio sample based on the first fused feature and the audio feature, to obtain a first predicted phrase comprises:
performing feature fusion on the first fused feature and the audio feature, to obtain a second fused feature; and
performing linear transformation on the second fused feature, to obtain a first transformed feature, and performing phrase prediction on the audio sample based on the first transformed feature, to obtain a first predicted phrase.

4. The method according to claim 1, wherein performing text prediction on the audio sample based on the audio feature, the phrase feature and the first fused feature, to obtain a first predicted text comprises:
performing feature fusion on the audio feature and the first fused feature, to obtain a third fused feature;
performing semantic prediction based on the third fused feature, to obtain a first semantic feature; and
performing text prediction on the audio sample based on the first semantic feature and the phrase feature, to obtain a first predicted text.

5. The method according to claim 4, wherein performing text prediction on the audio sample based on the first semantic feature and the phrase feature to obtain a first predicted text comprises:
performing feature fusion on the first semantic feature and the phrase feature, to obtain a fourth fused feature;
performing feature fusion on the fourth fused feature and the first semantic feature, to obtain a fifth fused feature; and
performing linear transformation on the fifth fused feature, to obtain a second transformed feature, and performing text prediction on the audio sample based on the second transformed feature, to obtain a first predicted text.

6. The method according to claim 5, wherein performing feature fusion on the first semantic feature and the phrase feature to obtain a fourth fused feature comprises:
using the first semantic feature as a query feature vector in an AED, and using the phrase feature as a key feature vector and a value feature vector in the AED;
determining an attention weight based on a degree of attention of the query feature vector to the key feature vector; and
performing a dot product operation on the attention weight and the value feature vector, to obtain a fourth fused feature.

7. The method according to claim 1, wherein performing text prediction on the audio sample based on the audio feature and the first fused feature, to obtain a second predicted text comprises:
performing feature fusion on the audio feature and the first fused feature, to obtain a sixth fused feature;
performing semantic prediction based on the sixth fused feature, to obtain a second semantic feature, and performing feature fusion on the second semantic feature and the phrase feature, to obtain a seventh fused feature;
performing feature fusion on the seventh fused feature and the second semantic feature, to obtain an eighth fused feature; and
performing semantic prediction based on the sixth fused feature and the eighth fused feature, to obtain a third semantic feature, and performing text prediction on the audio sample based on the third semantic feature, to obtain a second predicted text.

8. The method according to claim 1, wherein determining a third loss based on the second predicted text and the text label comprises:
determining a fourth loss and a fifth loss based on the second predicted text and the text label;
wherein the fourth loss is used to represent a degree of sequence alignment between the second predicted text and the text label, and the fifth loss is used to represent a degree of label difference between the second predicted text and the text label; and
determining the third loss based on the fourth loss and the fifth loss.

9. The method according to claim 1, wherein before training the audio recognition model based on the first loss, the second loss and the third loss, the method further comprises:
extracting an intermediate-layer audio feature from the audio sample;
performing feature fusion based on the intermediate-layer audio feature and the phrase feature related to the audio sample, to obtain a ninth fused feature;
performing phrase prediction on the audio sample based on the ninth fused feature and the intermediate-layer audio feature, to obtain a second predicted phrase, and determining a sixth loss based on the second predicted phrase and the phrase label;
performing text prediction on the audio sample based on the ninth fused feature, the intermediate-layer audio feature and the phrase feature, to obtain a third predicted text, and determining a seventh loss based on the third predicted text and the text label; and
performing text prediction on the audio sample based on the ninth fused feature and the intermediate-layer audio feature, to obtain a fourth predicted text, and determining an eighth loss based on the fourth predicted text and the text label.

10. The method according to claim 9, wherein training the audio recognition model based on the first loss, the second loss and the third loss comprises:
performing fusion processing on the first loss, the second loss, the sixth loss and the seventh loss, to obtain a bias loss;
performing fusion processing on the third loss and the eighth loss, to obtain a basic loss; and
determining a total loss of audio recognition based on the basic loss, the bias loss, and a preset bias weight, and training the audio recognition model based on the total loss.

11. An electronic device, comprising:
a memory for storing computer-executable instructions or a computer program; and
a processor for executing the computer-executable instructions or the computer program stored in the memory to implement operations of:
performing feature fusion on an audio feature of an audio sample and a phrase feature related to the audio sample, to obtain a first fused feature;
performing phrase prediction on the audio sample based on the first fused feature and the audio feature, to obtain a first predicted phrase, and determining a first loss based on the first predicted phrase and a phrase label of the audio sample;
performing text prediction on the audio sample based on the audio feature, the phrase feature and the first fused feature, to obtain a first predicted text, and determining a second loss based on the first predicted text and a text label of the audio sample;
performing text prediction on the audio sample based on the audio feature and the first fused feature, to obtain a second predicted text, and determining a third loss based on the second predicted text and the text label; and
training an audio recognition model based on the first loss, the second loss and the third loss.

12. The electronic device according to claim 11, wherein the processor is further configured to execute the computer-executable instructions or computer program to:
before the performing feature fusion on an audio feature of an audio sample and a phrase feature related to the audio sample, performing feature extraction on a plurality of phrases in a phrase list, to obtain a phrase feature sequence comprising a plurality of phrase features;
using the audio feature as a query feature vector in an Attention Encoder-Decoder (AED), and using the phrase feature sequence as a key feature vector in the AED;
determining a feature similarity between the audio feature and each phrase feature in the phrase feature sequence, according to a dot product operation between the query feature vector and the key feature vector; and
determining a phrase feature related to the audio feature from the phrase feature sequence based on the feature similarity.

13. The electronic device according to claim 11, wherein performing phrase prediction on the audio sample based on the first fused feature and the audio feature, to obtain a first predicted phrase comprises:
performing feature fusion on the first fused feature and the audio feature, to obtain a second fused feature; and
performing linear transformation on the second fused feature, to obtain a first transformed feature, and performing phrase prediction on the audio sample based on the first transformed feature, to obtain a first predicted phrase.

14. The electronic device according to claim 11, wherein performing text prediction on the audio sample based on the audio feature, the phrase feature and the first fused feature, to obtain a first predicted text comprises:
performing feature fusion on the audio feature and the first fused feature, to obtain a third fused feature;
performing semantic prediction based on the third fused feature, to obtain a first semantic feature; and
performing text prediction on the audio sample based on the first semantic feature and the phrase feature, to obtain a first predicted text.

15. The electronic device according to claim 14, wherein performing text prediction on the audio sample based on the first semantic feature and the phrase feature to obtain a first predicted text comprises:
performing feature fusion on the first semantic feature and the phrase feature, to obtain a fourth fused feature;
performing feature fusion on the fourth fused feature and the first semantic feature, to obtain a fifth fused feature; and
performing linear transformation on the fifth fused feature, to obtain a second transformed feature, and performing text prediction on the audio sample based on the second transformed feature, to obtain a first predicted text.

16. The electronic device according to claim 15, wherein performing feature fusion on the first semantic feature and the phrase feature to obtain a fourth fused feature comprises:
using the first semantic feature as a query feature vector in an AED, and using the phrase feature as a key feature vector and a value feature vector in the AED;
determining an attention weight based on a degree of attention of the query feature vector to the key feature vector; and
performing a dot product operation on the attention weight and the value feature vector, to obtain a fourth fused feature.

17. The electronic device according to claim 11, wherein performing text prediction on the audio sample based on the audio feature and the first fused feature, to obtain a second predicted text comprises:
performing feature fusion on the audio feature and the first fused feature, to obtain a sixth fused feature;
performing semantic prediction based on the sixth fused feature, to obtain a second semantic feature, and performing feature fusion on the second semantic feature and the phrase feature, to obtain a seventh fused feature;
performing feature fusion on the seventh fused feature and the second semantic feature, to obtain an eighth fused feature; and
performing semantic prediction based on the sixth fused feature and the eighth fused feature, to obtain a third semantic feature, and performing text prediction on the audio sample based on the third semantic feature, to obtain a second predicted text.

18. The electronic device according to claim 11, wherein determining a third loss based on the second predicted text and the text label comprises:
determining a fourth loss and a fifth loss based on the second predicted text and the text label;
wherein the fourth loss is used to represent a degree of sequence alignment between the second predicted text and the text label, and the fifth loss is used to represent a degree of label difference between the second predicted text and the text label; and
determining the third loss based on the fourth loss and the fifth loss.

19. The electronic device according to claim 11, wherein before training the audio recognition model based on the first loss, the second loss and the third loss, the operations further comprise:
extracting an intermediate-layer audio feature from the audio sample;
performing feature fusion based on the intermediate-layer audio feature and the phrase feature related to the audio sample, to obtain a ninth fused feature;
performing phrase prediction on the audio sample based on the ninth fused feature and the intermediate-layer audio feature, to obtain a second predicted phrase, and determining a sixth loss based on the second predicted phrase and the phrase label;
performing text prediction on the audio sample based on the ninth fused feature, the intermediate-layer audio feature and the phrase feature, to obtain a third predicted text, and determining a seventh loss based on the third predicted text and the text label; and
performing text prediction on the audio sample based on the ninth fused feature and the intermediate-layer audio feature, to obtain a fourth predicted text, and determining an eighth loss based on the fourth predicted text and the text label,
wherein training the audio recognition model based on the first loss, the second loss and the third loss comprises:
performing fusion processing on the first loss, the second loss, the sixth loss and the seventh loss, to obtain a bias loss;
performing fusion processing on the third loss and the eighth loss, to obtain a basic loss; and
determining a total loss of audio recognition based on the basic loss, the bias loss, and a preset bias weight, and training the audio recognition model based on the total loss.

20. A computer-readable storage medium having stored thereon computer-executable instructions or a computer program that when executed by a processor, implement or implements a method, the method comprising:
performing feature fusion on an audio feature of an audio sample and a phrase feature related to the audio sample, to obtain a first fused feature;
performing phrase prediction on the audio sample based on the first fused feature and the audio feature, to obtain a first predicted phrase, and determining a first loss based on the first predicted phrase and a phrase label of the audio sample;
performing text prediction on the audio sample based on the audio feature, the phrase feature and the first fused feature, to obtain a first predicted text, and determining a second loss based on the first predicted text and a text label of the audio sample;
performing text prediction on the audio sample based on the audio feature and the first fused feature, to obtain a second predicted text, and determining a third loss based on the second predicted text and the text label; and
training an audio recognition model based on the first loss, the second loss and the third loss.
